(19) United States
(12) Patent Application Publication
(10) Pub. No.: US 2003/0071714 A1
(43) Pub. Date: Apr. 17, 2003

(54) Method for initializing an access control system having a plurality of electronic keys and a plurality of objects

(76) Inventors: Matthias Bayer, Birgland (DE); Torsten Thiel, Schwindegg (DE); Ulrich Emmerling, Kelheim (DE)

Correspondence Address: Bruce W. Slayden II, Baker Botts LLP, 910 Louisiana, Houston, TX, 77002-4995, US

(21) Appl. No.: 10/272,100

(22) Filed: Oct. 16, 2002

Related U.S. Application Data
(60) Provisional application No. 60/329,661, filed on Oct. 16, 2001.

(30) Foreign Application Priority Data
Jan. 22, 2002 (EP) EP02001495.7

(51) Int. Cl. G06F 7/00

(52) U.S. Cl. 340/5.2; 340/5.72

(57) ABSTRACT

If a key (A) which is already assigned with authorization to a first object (A1) is placed in the vicinity of a second object (B), and this object (B) is placed in an initialization state, the data (X) of the key (A1) is written into the second object (B), or the data (Y) of the second object (B) is written into the key (A1). The key (A1) is then assigned with authorization to the second object (B). In this way, the key can be assigned to further objects (A, C) as authorized by means of an initialization.

### BACKGROUND OF THE INVENTION

The invention relates to a method for initializing an access control system with a plurality of electronic keys, which are assigned to a plurality of objects, in order to confirm access authorization.

In access control systems, the authorization for the access to an object and for the use of the object is confirmed by authorized keys. In order to obtain the highest possible degree of security, electronic keys are used in which the authorization is usually transmitted as a code signal in wireless fashion.

The prior art has disclosed (DE 195 26 530 C1) an access control system, an immobilizer for a motor vehicle in said publication. The motor vehicle has a plurality of controllers which are integrated into what is referred to as a distributed immobilizer. Using electronic keys it is possible to confirm an authorization to start the vehicle and thus use it. If a controller has to be exchanged, the new controller must firstly be initialized, i.e. provided with a valid and authorized code, for the controller to be able to recognize the code signal of the keys as authorized.

At least two keys which both transmit their code signals to the new controller during an initialization state are required for the initialization. The encoding data which is contained in the code signal is then stored in said controller.

In order to be able to place the system at all in the initialization state, in the known access control system an external diagnostic device is connected to the motor vehicle which puts all the controllers in the initialization state only when an additional authorization is confirmed. Only in this initialization state is the encoding data of the keys transferred into the controllers to be initialized.

In the known access control system, the authorization is allocated only within the system, i.e. a motor vehicle and the keys assigned to it. Only new controllers which are installed in the motor vehicle and which are associated with the access control system of the motor vehicle can be initialized. Therefore, only one access control system of a single motor vehicle can be initialized using the keys. In this way, one or more keys are also assigned to just a single motor vehicle.

### SUMMARY OF THE INVENTION

An object of the invention is to provide a simple method for initializing an access control system with a plurality of electronic keys and a plurality of objects.

This object is achieved according to the invention by means of a method for initializing an access control system having a plurality of electronic keys and a plurality of objects defined by the following method steps:

a first key which is already assigned with authorization to a first object is placed in the vicinity of a second object,

the second object is put into an initialization state,

a request signal which is output by a transmitter of the second object is triggered,

a response signal is output by a transmitter of the first key if a receiver of the key has previously received the request signal, the response signal having a first characteristic identifier, and

the first identifier is stored in the second object as a new, valid identifier or the identifier of the second object is transmitted to the key and stored there as a new, valid identifier.

An embodiment of the present invention is, for example, an access control system having a plurality of electronic keys and a plurality of objects, wherein each object comprises an object control device coupled with an object data transceiver having an object memory for reading and writing at least one identifier, and wherein each key comprises a key control device coupled with a key data transceiver having a key memory for reading and writing at least one identifier.

In this method, firstly a key which is already assigned with authorization to a first object (initialized) is placed in the vicinity of a second object to which it was previously not assigned. The second object is then put into an initialization state. During the initialization state, the already initialized key outputs a code signal which has a characteristic identifier and encoding data. The characteristic identifier is then stored in the second object as a new, valid identifier, if the new identifier has a higher priority than the previous identifier, or the identifier of the second object is stored as a new, valid identifier for the key.

This has the advantage that a plurality of objects can be assigned as authorized to at least one key in order to be able to lock or unlock or use all these objects with authorization with this key. It is also possible to assign a plurality of keys to the objects. A plurality of objects can then be initialized by just using one key. In this way, a plurality of access control systems having a plurality of keys which are each assigned to one object can be linked to a single access control system having a plurality of objects and a plurality of keys.

The invention can be further developed advantageously as characterized in the dependent claims.

### BRIEF DESCRIPTION OF THE DRAWINGS

Exemplary embodiments of the invention are explained in more detail below with reference to the schematic drawings, in which:

FIG. 1 shows an access control system for a plurality of objects and having a plurality of keys by means of the exemplary embodiment of an access control system for motor vehicles,

FIGS. 2 and 3 each show a schematic view of an access control system by means of the exemplary embodiment of a motor vehicle, and

FIG. 4 shows a flowchart of a method for initializing an access control system of a plurality of objects.

### DETAILED DESCRIPTION OF THE PREFERRED EMBODIMENTS

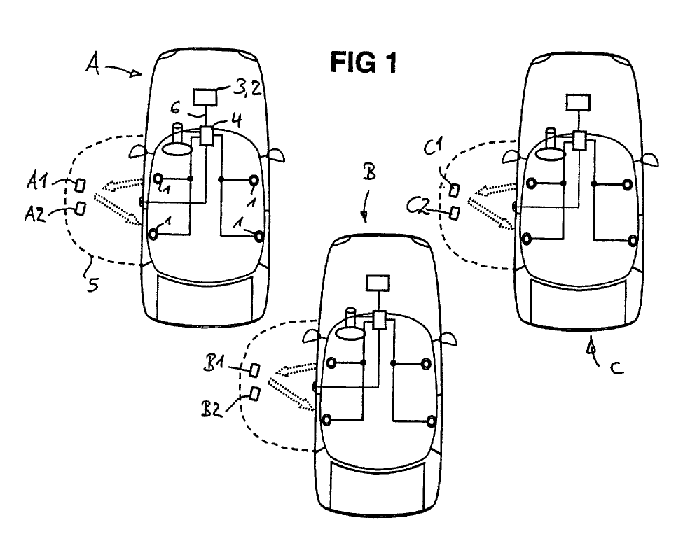

A method for initializing an access control system having a plurality of electronic keys A1, A2, . . . C1, C2 (FIG. 1) and a plurality of objects is described by way of example with reference to an access control system for a motor vehicle A, B or C. Of course, this method can also be used in other objects, for example entry doors, garage doors, hotel rooms, strong rooms, etc.

Firstly, it is assumed that there are a plurality of motor vehicles (for example three motor vehicles A, B and C, as illustrated in FIG. 1), which are each assigned, for example, two keys A1, A2; B1, B2; and C1 C2 as already authorized for the respective access control system of each motor vehicle. Using the keys A1 etc., it is possible to lock or unlock door locks 1 of the respectively assigned motor vehicle or release its immobilizer 2 in an authorized way. In this way, by means of the keys, access with authorization is obtained to each motor vehicle, i.e. the motor vehicle can thus be used with authorization.

A specific, characteristic identifier is stored in each key. The identifier of keys A1 and A2 will firstly be assumed to be X/1, that of keys B1 and B2 will firstly be assumed to be Y/1 and that of the keys C1 and C2 will firstly be assumed to be Z/1. The identifier is output in the signal from the keys together with an identification number for a motor vehicle, encoding data and, if appropriate, control data. Other identifiers can be written over the identifiers.

The identifier is used during the initialization, as will be described in more detail later, to inform, when necessary, each motor vehicle and each key which identifier is necessary for all the parts assigned to the access control system. The identifier is additionally used as what is referred to as a wake-up, with which the keys are changed from the state of rest to the normal operating state—when the identifier is received.

The respective identification number defines a specific motor vehicle and is unique for each motor vehicle. The identification number (for example vehicle identification no.) is usually used for encryption/encoding.

The electronic keys have a transponder function. A transponder is to be understood as a device which receives a signal (for example interrogation or request signal) with a receiver and in response automatically sends back a signal (for example response signal or code signal) via a transmitter. In this way, a bidirectional dialog (also referred to as question/response dialog) can be carried out between an object and the key.

The electronic keys can also have a remote control function. Unidirectional outputting of a closing instruction, by means of which, for example, the lock system can be locked or unlocked, is associated with this.

When the signals are output, cryptological or encrypted data (is referred to as encoding data) is output at the same time in modulated form. Only if this encoding data can be detected as authorized in the receiver is a function in the object to be controlled carried out in accordance with the control instruction which is also transmitted at the same time.

When a user approaches his motor vehicle, he can unlock the doors with the key (outputting of the code signal by, for example, activating a remote control push button key on the car key) and get into his motor vehicle so as to carry out the question/response dialog between an immobilizer 2 and the respective key. When there is authorization, the immobilizer 2 is deactivated and the user can start the engine and drive away, i.e. use his motor vehicle without restriction.

For the key and motor vehicle to “understand” one another, the corresponding encoding data must be contained both in the motor vehicle and in the key. This encoding data can be assigned to each vehicle during what is known as a first initialization at the end of the line when the motor vehicle is manufactured. Here, the respective data (identifier and identification number) is transferred both to the key and to the motor vehicle (to a central controller 3 for the access control) and stored there. This data cannot be read from the outside but rather can only be used during the normal operation of the access control system.

By virtue of the electronic systems for access controls, high code variations, and thus the security, are so high that each motor vehicle can be assigned in each case at least one key with its own encoding data. This prevents the key being able, by chance, to operate another access control system, i.e. to enable another object to be used with authorization, as long as the key is not initialized for said object.

However, with the invention there is the problem of how a key which has already been assigned to an access control system of a motor vehicle can also be approved for another access control system of another motor vehicle. It is even intended that a plurality of keys will be approved for, in each case, a plurality of motor vehicles, i.e. a plurality of access control systems are to be linked to one another to form one access control system. Such situations occur in particular with large fleets of cars in which a plurality of vehicles are to be used by a plurality of drivers. Each driver can then have a key which is then to be authorized for a plurality of vehicles.

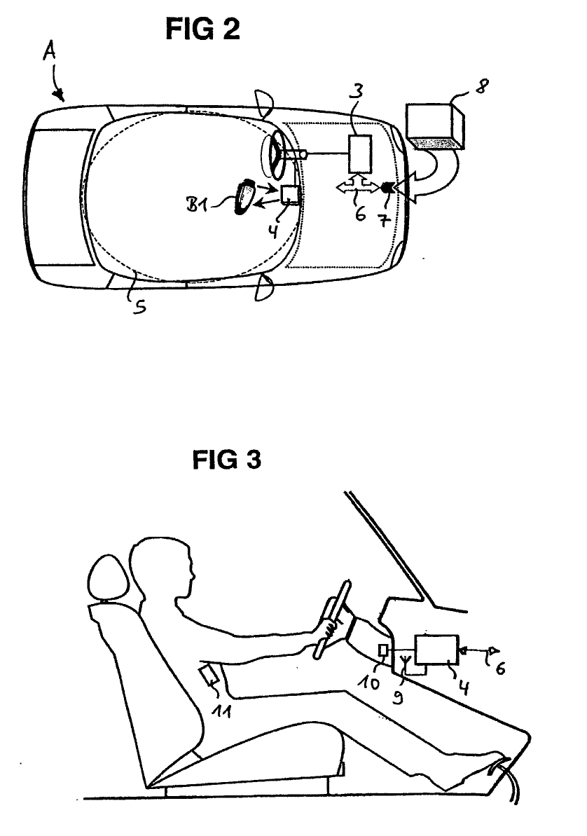

In order to initialize such an access control system, a portable key, which advantageously has a transponder for receiving and transmitting signals, is firstly required. Consequently, a transceiver unit 4 (FIG. 2), which outputs a signal when triggered and can subsequently receive a code signal from the key, is also required at the object end.

In the exemplary embodiment according to FIG. 2, the object-end transceiver unit 4 is arranged in the interior of the vehicle. The range 5 of the signals which are output by the transceiver unit 4 is essentially restricted to the interior of the motor vehicle as a result of the damping/shadowing by the body of the vehicle. The transceiver unit 4 is connected via a bus line 6 to a central controller 3 for the access control system. The central controller 3 can also be integrated in a controller (for example the engine controller) which is provided in the motor vehicle in any case.

The bus line 6 has a diagnostic interface 7 via which an external diagnostic device 8 can be connected to the motor vehicle and to all the electronic devices connected to the bus 6.

FIG. 3 illustrates in somewhat more detail the transceiver unit 4 in the interior of the motor vehicle. It has an antenna 9 via which signals can be transmitted and received. Furthermore, it can have a key receptacle 10 into which the key is inserted in order to carry out the question/response dialog with the transceiver unit 4. The key can also be inserted into the key receptacle 10 in order to carry out the initialization.

The key receptacle 10 may be, for example, a conventional ignition lock. However, this assumes that the key has a conventional mechanical beard, while the electronics for outputting the code signals are integrated in the handle of the key. A key receptacle 10, which accommodates other keys, for example a card 11 of the size of a chip card, may also be provided in the vehicle.

If the signals which are output by the transceiver 4 via the antenna have a large range (1 to 2 m), the key does not necessarily need to be inserted into the key receptacle 10 but rather can be stored in the vehicle as desired or remain in the user's pocket. However, this assumes that the transmitter of the key outputs signals which also have a large range so that they can be received by the transceiver unit 4.

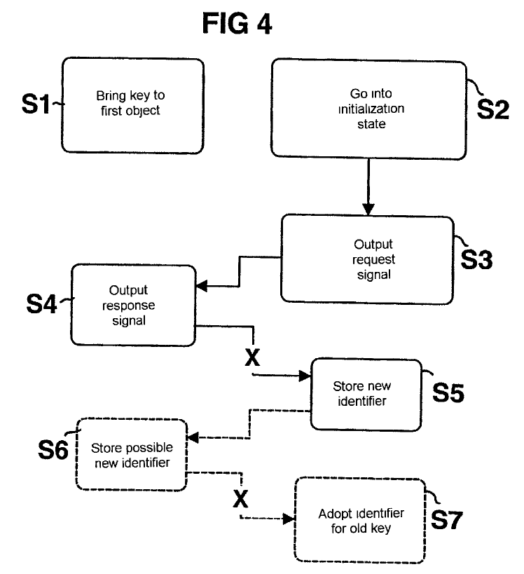

The method for initializing the key with respect to the motor vehicle will now be explained in more detail with reference to FIG. 4. Here, the method steps which are executed at the key end are illustrated on the right-hand side, and the method steps which occur at the object end are illustrated on the right-hand side.

Exemplary embodiment with defined training sequence:

Firstly, in step S1 a key A1 which has already been trained or assigned (initialized) with authorization for an access control system of a first object (the vehicle A) is placed in the vicinity of the second object, here the second motor vehicle B.

The second object (here the motor vehicle B) is put into an initialization state in step S2. For this purpose, for example, the external diagnostic device 8 can be connected to the diagnostic interface 7. By means of the diagnostic device 8 a signal is transmitted—given additional confirmation of authorization to do this—as a result of which the central controller 3 puts the access control system of the motor vehicle into the initialization state.

This results in the keys B1 and B2 (which had been assigned to the motor vehicle B) being erased as authorized. As a result, the motor vehicle B can no longer be used by means of the keys B1 and B2 without these keys being later trained once more for the motor vehicle B.

During this initialization state, it is then possible, in step S3, to trigger for a request signal which is output to the key A1 by the transceiver unit 4 in the motor vehicle (the condition for this with this exemplary embodiment is that the motor vehicle B is unlocked and the key A1 is located in the interior).

The triggering of the request signal can be carried out, for example, by switching an ignition switch or manually activating some other switch. The key A1 can be detected as being located within the motor vehicle by means of sensors. Then, the request signal is automatically output—in the initialization state.

If the key A1 receives the request signal, it sends, for its part, an encoded response signal back in step S4. This response signal has a characteristic identifier X/1 by means of which all the parts which are assigned to the access control system are identified as belonging to it. Apart from the identifier, the response signal can also contain other information, for example a code and a vehicle identification number.

The identifier and the identification number of the motor vehicle A are communicated to the motor vehicle B by means of the response signal. In step S5, the central controller 3 adopts the transmitted identifier as the identifier which will be valid in future. Furthermore, from the received identification number, vehicle B derives an identification number which differs from it.

Thus, those keys which were previously authorized for the motor vehicle A have the same identifier as the motor vehicle B.

The keys B1 and B2, which are now no longer authorized for the motor vehicle B, can then also be trained to the vehicle B in steps S6 and S7.

The keys B1 and B2 can now also be trained to the motor vehicle A (not illustrated in FIG. 4). The new identifier and the associated identification numbers of all the motor vehicles (A and B) which are assigned to the access control system are then stored in all the keys (A1 to B2).

The motor vehicle C can then be initialized with the key B1 or B2. And further motor vehicles and keys can be initialized.

Exemplary embodiment with variable training sequence:

The key B1 is firstly trained to the motor vehicle A, after that the key C1 is trained to the motor vehicle A and then the key A1 is trained to the motor vehicle C.

Firstly, the key B1 is placed in the vicinity of the motor vehicle A, and the vehicle A is put into the initialization state. However, the keys A1 and A2 remain firstly authorized for the vehicle A (in contrast to the previous exemplary embodiment).

Then, in the question/response dialog the identifier Y of the key B1 is transferred to the transceiver unit 4 and thus to the central controller 3. There, the transferred identifier Y is compared with a previous identifier X. The identifier Y which has just been transferred is transferred, or not, as a new identifier Y in the central controller 3 depending on whether said identifier Y is greater or is to have priority. The priority of the identifiers is already defined once during fabrication or the first initialization.

If the new identifier Y is transferred into the central controller 3, the previous identifier Y is retained in the key B1 as valid (and the motor vehicle A has the identifier of the key B1). The keys A1 and A2 must then once more be brought to the motor vehicle A, the identifier Y of the key B1 being then transferred from the motor vehicle A.

If the identifier Y of the key B1 is not transferred the previous identifier X of the motor vehicle A must be transmitted to the key B1 and stored there as a new valid identifier X.

If the key B1 has then received a new identifier X from a motor vehicle, this identifier must be transmitted in the other motor vehicle and its key must also be transmitted so that the keys are valid for all the motor vehicles.

For this reason, the keys A1 and A2 are then brought once more to the motor vehicle A (if the identifier has changed). The keys B1 and B2 are also brought to the motor vehicle B.

The keys C1 and C2 can now be trained to the motor vehicle A, and the keys B1 and B2 to the motor vehicle A. Finally, the keys A1 and A2 can be trained to the motor vehicle C.

However, in this context it may be that it is not necessary to make any changes in the identifiers if the authorized identifier has already been stored.

After the storage of the identifier, the initialization for the respective motor vehicle can be automatically terminated.

Instead of initiating the initialization state with an external diagnostic device, other methods can also be used to put the motor vehicle into the initialization state. For example, the ignition key can be inserted into the ignition lock and by means of an unusual activation (for example switching on and off nine times) it is possible to detect that an initialization state is to be assumed now. Any other actions, which have also been previously defined as the means of triggering the initialization and which then cause the initialization state to be entered can also be performed. However, these actions must be unusual actions which the driver does not usually perform when using his vehicle, so that it is possible for the access control system to clearly detect that an initialization state is to be entered.

The characteristic identifier may be what is referred to as a wake-up pattern (WUP) by means of which the access control system detects immediately that it is a case of an assigned key, and afterwards only the encoding has to be respectively checked to determine whether it corresponds to an assigned encoding. By means of the wake-up pattern, the keys are changed from the state of rest (low energy consumption) into the normal operating mode (normal energy consumption) if the key has an identifier which is assigned to the access control system.

Conventional encryption methods, such as are already known in many forms for motor vehicles (alternating code, fixed code, cryptocode etc.) can be used for the encoding. For the encoding or encryption, the identification number of the motor vehicle can advantageously also be used. If the received encoding data does not correspond directly to the expected encoding data, it is possible, by continuing the calculation of the encoding within what is referred to as a capture range, to determine whether or not there is authorization.

The term “key” is to be understood as an electronic key or else what is referred to as an ID transmitter or code transmitter which, irrespective of the design of the housing in which it is arranged, is suitable for transmitting a code signal with encoded or encrypted data to an object, by means of which data authorization for access to the object is confirmed. In the motor vehicle, this is specifically the authorization to lock or unlock door locks 1 (and/or tollgate locks) or to deactivate an immobilizer 2.

The signals which are transmitted between the respective object and the key may be transmitted in a line-bound or wire-free fashion, inductively, by radio, optically or acoustically.

In such an access control system, a multiplicity of keys can be assigned to a multiplicity of objects as authorized for all the objects. In addition to the identifier and the identification numbers for the respective object it is also possible to store the number of all the keys present in the system—for example for insurance purposes.

Such access control systems may advantageously be used for hire cars and fleets of vehicles. Initially, the logistics of keys, transfer of keys and handing over vehicles is made easier. Even if a vehicle is removed from the access control system, the other keys for the remaining vehicles continue to be valid. The “removed” vehicle can be re-initialized with its keys so that these keys are no longer valid for the remaining access control system either.

If a key is lost, the access control system merely needs to be re-initialized. Authorized access is then no longer possible to the associated objects using the lost key. If a key is damaged, no further action is necessary as long as this key cannot be used illegitimately.

If a vehicle is stolen without its key, no change is necessary. However, if the vehicle is stolen with its key, the thief can operate his vehicle with the single key, but not the other vehicles, if the access control system is re-initialized—without the stolen key.

If there is provision for initialization to be performed only by means of an external diagnostic device 8, and additionally by confirmation of an additional authorization (driver's license, personal identification papers, PIN number etc. as well as possibly transmission of data from a central database of the manufacturer of the vehicle) at an authorized contracted workshop, a thief who steals a motor vehicle with its key cannot newly train new keys or any other motor vehicles assigned to the access control system. Then, even in the case of what is referred to as valet parking, it is not possible for the service provider to make illegitimate use of the key provided to him.

If the number of all the trained keys is stored, it is possible, if the vehicle is stolen (without a key), to use the stored number to confirm to the insurance company that in fact all the keys are also still present and only the motor vehicle has been stolen.

The term “initialization” is to be understood as initial storage, or storage which is repeated when necessary, of encoding data in the keys and in the object (lock or central controller 3). Access can be obtained to the object, and thus also use of the object permitted, only with this data which is specific to each object, and if appropriate to each user. The first initialization usually takes place after manufacture (in the case of a motor vehicle at the end of the line when the motor vehicle is manufactured). As no key had previously been assigned to the access control system, no key is required for the very first initialization. When any further, later initialization (also referred to as re-initialization) occurs, already initialized keys are then required. The initialization can also be referred to as “training of the access control system” or “assignment of keys to objects”. The invention is based on the idea that each object per se has already been initialized at least once with a certain number of keys, but there is still no key present which is initialized for at least two objects.

The encryption and the comparison with stored encoding data can also be carried out by means of other confirmation methods for identification methods, such as biometric methods (fingerprint, recognition of the iris or of the face, voice recognition).

The method according to the invention can be carried out with all objects with which it is necessary to confirm access (incl. use) only when there is authorization by means of an electronic key, and in which a plurality of keys are to be assigned to a plurality of objects. The invention is therefore not restricted to use in a motor vehicle. It can also be used with other objects such as personal computers, mobile telephones, locks of hotel doors, security zones with a separate access, etc.

1. Method for initializing an access control system having a plurality of electronic keys and a plurality of objects defined by the following method steps:
a first key which is already assigned with authorization to a first object is placed in the vicinity of a second object,
the second object is put into an initialization state,
a request signal which is output by a transmitter of the second object is triggered,
a response signal is output by a transmitter of the first key if a receiver of the key has previously received the request signal, the response signal having a first characteristic identifier, and
the first identifier is stored in the second object as a new, valid identifier.

2. The method as claimed in claim 1, wherein the new, valid identifier, which is stored both in the first key and in the second object, is stored in the first object during a re-initialization of the first object with the first key, or is stored in a second key during a renewed initialization of the second object with the second key.

3. The method as claimed in claim 1, wherein each key is inserted into a key receptacle of the first or second object in order to receive signals.

4. The method in claim 1, wherein the first and second objects are motor vehicles, and the keys are vehicle keys in the form of an ignition key or a card with which unauthorized access to the motor vehicle and the use of the motor vehicle are made possible.

5. The method as claimed in claim 1, wherein the signals are transmitted between the respective object and the key in a line-bound or wireless fashion, inductively, by radio, optically or acoustically.

6. The method as claimed in claim 4, wherein, in order to place the motor vehicles in the initialization state, in each case an external diagnostic device is connected to a diagnostic interface of the respective motor vehicle, a trigger signal, as a result of which the initialization state is entered, being transmitted to the motor vehicle via said diagnostic interface.

7. The method as claimed in claim 4, wherein the respective key is present in the interior of the vehicle during the initialization or is entered into the ignition lock or some other key receptacle, the request signal being triggered by activating the ignition lock, the key receptacle or a start switch.

8. Method for initializing an access control system having a plurality of electronic keys and a plurality of objects defined by the following method steps:
a first key which is already assigned with authorization to a first object is placed in the vicinity of a second object,
the second object is put into an initialization state,
a request signal which is output by a transmitter of the second object is triggered,
a response signal is output by a transmitter of the first key if a receiver of the key has previously received the request signal, the request signal having a first characteristic identifier, and
the identifier of the second object is transmitted to the key and stored there as a new, valid identifier.

9. The method as claimed in claim 8, wherein the new, valid identifier, which is stored both in the first key and in the second object, is stored in the first object during a re-initialization of the first object with the first key, or is stored in a second key during a renewed initialization of the second object with the second key.

10. The method as claimed in claim 8, wherein each key is inserted into a key receptacle of the first or second object in order to receive signals.

11. The method in claim 8, wherein the first and second objects are motor vehicles, and the keys are vehicle keys in the form of an ignition key or a card with which unauthorized access to the motor vehicle and the use of the motor vehicle are made possible.

12. The method as claimed in claim 8, wherein the signals are transmitted between the respective object and the key in a line-bound or wireless fashion, inductively, by radio, optically or acoustically.

13. The method as claimed in claim 11, wherein, in order to place the motor vehicles in the initialization state, in each case an external diagnostic device is connected to a diagnostic interface of the respective motor vehicle, a trigger signal, as a result of which the initialization state is entered, being transmitted to the motor vehicle via said diagnostic interface.

14. The method as claimed in claim 11, wherein the respective key is present in the interior of the vehicle during the initialization or is entered into the ignition lock or some other key receptacle, the request signal being triggered by activating the ignition lock, the key receptacle or a start switch.

15. Access control system having a plurality of electronic keys and a plurality of objects, wherein each object comprises an object control device coupled with an object data transceiver having an object memory for reading and writing at least one identifier, and wherein each key comprises a key control device coupled with a key data transceiver having a key memory for reading and writing at least one identifier.

16. System as in claim 15, wherein the object control device comprises an initialization circuit.

17. System as in claim 16, wherein the initialization circuit is coupled with an external device to put said object control device into an initialization mode.

18. System as in claim 16, wherein the initialization circuit initiates a request signal during an initialization mode.

19. System as in claim 17, wherein the initialization circuit controls said memory to allow writing to said memory only during an initialization mode.
